(19) United States
(12) Patent Application Publication
(10) Pub. No.: US 2005/0118425 A1
(43) Pub. Date: Jun. 2, 2005

(54) Microcapsules containing biomedical materials

(76) Inventors: Ronald F. Childs, Burlington (CA); Feng Shen, Hamilton (CA); Sanju Wang, Hamilton (CA)

Correspondence Address: Clifford W Browning;Bank One Center Tower, 111 Monument Circle, Suite 3700, Indianapolis, IN, 46204-5137, US

(21) Appl. No.: 10/513,834

(22) PCT Filed: May 7, 2003
(86) PCT No.: PCT/CA03/00671

Related U.S. Application Data
(60) Provisional application No. 60/377,972, filed on May 7, 2002.

(51) Int. Cl. B65B 1/00; B32B 5/16

(52) U.S. Cl. 428/402.2; 264/4.1

(57) ABSTRACT

Biomedical materials are encapsulated in ionically crosslinked polymer capsules, preferably alginate microcapsules. The alginate capsules are then subjected, in a liquid vehicle, to an ethylenically unsaturated monomer and an initiator, to induce polymerization of the unsaturated monomer and therey enhance the strength of the capsule wall. The microcapsules can be after-treated with, for example, polysine and alginate to reduce their tendency to elicit an immune response if implanted in an animal. The invention extends to the microcapsules and also to a method of treating or preventing medical conditions in an animal particularly a human, by implanting microcapsule containing biomedical material in the animal.

### FIELD OF THE INVENTION

The present invention relates to microcapsules. More specifically, the present invention relates to the formation of microcapsules that can be implanted in an animal and/or human. The microcapsules may contain biomedical material for example, cells, especially recombinant cells for gene therapy, proteins and/or drugs for long term delivery.

### BACKGROUND OF THE INVENTION

It is known that microcapsules can be prepared from alginate cross-linked with Ca²⁺. These capsules are well suited for the incorporation of living cells, and allow the diffusion of nutrients into and expressed proteins out of the capsules. Particularly if the microcapsules are coated first with poly-L-lysine ad then subsequently with alginate, they show little image response when implanted within a mammalian host. They have been used as a convenient means of supplying a hormone to a human or non-human animal lacking the ability to produce such a material. This classical method of encapsulation has been described in the literature (F. Lim et al. (1981) J. Pharm. Sci. 70: 351) and used to treat diabetes (A. M. Sun (1988) Meth. Enzymol. 137: 575), liver failure (F. Lim et al. (1980) Science 210, 908-910), and kidney failure (P. A. Rivas-Vetencourt et al. (1997) Trans Proc 29, 920-922; S. Prakash et al. (1996) Nat Med 2(s), 883-887) in animal models and human (P. Soon-Shiong et al. (1994) Lancet 343, 950-951).

The disclosures of these publications are hereby incorporated by reference. The encapsulation technique is a simple one. However, it suffers from a major drawback in that the capsules are insufficiently stable and degrade with time. The rate of this degradation and failure, which depends on the nature of the host organism, severely limits the application of this approach to the treatment. of human patients. It would appear, although the applicants do not want to be bound by these suggestions, that causes of failure include the following. The capsules have an inherent lack of strength such that when subject to an osmotic shock they disintegrate. Further, when implanted in a host, the Ca²⁺ used to cross-link the alginate is leached out of the capsules. This leaching would appear to be enhanced by the presence of albumin in the host since albumin is a major transporter of ca²⁺.

It has been suggested that to prevent such degradation, it would be desirable to replace the ionic cross-linking of the alginate associated with the Ca²⁺ with a covalent cross-linking agent. Several attempts have been made to do this including the work described in U.S. Pat. No. 5,837,747 of Soon-Shiong et al., In this patent, a process for increasing capsule strength is described in which the alginate is first reacted with acrylic hydride to incorporate an acrylate ester into the starting alginate. The capsules are then made in the normal manner using Ca²⁺ but subsequently subjected to light so as to cause a photopolymerization of the acrylate functionalities. In order to enhance this photopolymerization, and thereby covalent cross-linking, additional monomers such as N-vinylpyrrolidone were added to the solution surrounding the capsules. Comparable covalent modifications using methacrylic anhydride have been reported by A. Kimberly et al, (Journal of Biomedical Materials Research. 2001, Vol 55, 254-255) and also maleic anhydride. Soon-Shiong also has a number of patents in the area that represent further modifications on the theme. In some of these cases, reagents are used that would be lethal to any encapsulated cells (F. Lee et al. in Science 213;233-235 (1981) and in U.S. Pat. No. 4,671,954). The patents and publications mentioned in this paragraph are hereby incorporated by reference.

The processes described in the above publication teaching acrylic anhydride do generate capsules with enhanced strength. However, they are inconvenient for the following reasons.

Reagents such as acrylic anhydride are expensive as their preparation and isolation are difficult. These reagents cannot be conveniently stored for long periods.

Acrylic anhydride is often made by reaction of acrylic acid with acetic anhydride, and the obtained acrylic anhydride may be contaminated with acrylic acid, acetic anhydride and acetic acid. Moreover, after the treatment of the alginate with these reagents any residual small molecules must be removed. In view of the intended utility of the capsules for implantation into animals, purity of products is of great concern. Hence, great care Oat be exercised in purification, and this is preferably effected by dialysis of the alginate.

In addition, the capsules produced by such methods have relatively rough surfaces and are smaller in diameter and thus more dense than capsules made using the previously known route. The relatively rough surface of the capsules produced by the method of soon-Shiong is a significant disadvantage. It is, of course, desirable that capsules implanted into an animal for medical reasons shall elicit little or, better, no immune response. AB a generality it is found that rough surfaces exploit greater immune response than smooth surfaces.

Lately, in the teaching of Soon-Shiong's U.S. Pat. No. 5,837,747, the covalent crosslinking agent and the alginate are equally interspersed throughout the capsule, which means that the encapsulated material in in close proximity with the covalent cross-linking prior to initiation of the photopolymerization. When free radical polymerization is induced, a number of free radicals could be formed in close proximity to the encapsulated material, which could lead to unwanted reactions due to the high reactivity of free radicals. In the case of encapsulated cells, free radicals can negatively impact cell viability.

Another route that has been explored in a variety of situations involves forming interpenetrating networks of calcium alginate with another polymer such as poly(acrylic acid). This has been described by Vacanti et al. (U.S. Pat. No. 5,716,404) to produce materials for breast tissue engineering. Einig et al. (U.S. Pat. No. 5,230,901) teach a similar technique to form sustained release tablets by using a mixture of alginates and polyacrylates. H. Sun et al.(European Polymer Journal, 1996, 32(1):101-104) have described semi-interpenetrating networks involving alginate and poly(acrylic acid) as absorbent materials. They reported that the swelling properties of the alginate were substantially modified by the presence of the poly(acrylic acid). T. Mano et al. (Journal of Fermentation and bioengineering, 1992, 73(6): 486-489) have reported a new immobilization method of mammalian cells using alginate and polyacrylate. The patents and articles referred to in this paragraph are incorporated herein by reference.

Applicants have made capsules by mixing sodium alginate with poly(acrylic acid) or its sodium salt and adding this solution to calcium chloride. The capsules indeed had enhanced strength when subjected to osmotic shock. However, those based on an admixture with poly(acrylic acid) did not have good long term stability. Those based on sodium poly(acrylate) would appear to have better long term stability. However, while these latter capsules exhibit good survival rates of incorporated cells, the capsules are still not sufficiently robust for long term use.

The technique involving the physical mixture of alginate with a further polymer is simple to use. However, it is unlikely that all the problems associated with long term stability will be solved by this approach.

Another approach to encapsulation is taken by Desai et al in U.S. Pat. No. 5,334;640, who use ionically crosslinked and covalently crosslinked components to encapsulate materials. As ionically crosslinked components, Desai et al use an alginate, and as covalently crosslinkable component, they use a vinyl modified poly (ethylene glycol) (PEG). The amount of vinyl modified PEG used by Desai et al is considerable, and the modified PEG and alginate are used simultaneously to form an interpenetrating network of polymers encapsulating the encapsulated material, The amount of modified PEG used by Desai et al is great, far exceeding the amount of alginate, so that the formed capsule is in reality a PEG capsule, rather than an alginate capsule. Again in this case, covalently crosslinkable components are interspersed through the ionically crosslinkable components, so that radicals formed during the photopolymerization might negatively interact with the encapsulated material.

### SUMMARY OF THE INVENTION

In one aspect, the present invention provides a process for encapsulating a biomedical material, which comprises incorporating the biomedical material in capsules of an ionically crosslinkable polymeric material, and contacting the capsules with a liquid vehicle comprising an ethylenically unsaturated molecule and an initiator.

In one embodiment, the ionically crosslinkable polymeric material is an alginate. In another embodiment, the initiator is a photoinitiator and free-radical polymerization is induced by irradiation.

In some preferred embodiments of the invention, the biomedical material to be encapsulated is a living cell, possibly genetically modified, such as recombinant cells for gene therapy. In other embodiments, the biomedical material is a protein or a drug for long term slow release.

The capsules subsequently may be further treated to reduce any tendency to elicit an immune response when administered to an animal, for instance a human. This can be done, for instance, by coating capsules with a polyamino acid, for example poly-L-lysine or poly-L-arginine, followed by further coating with ionically crosslinkable polymeric material, preferably alginate.

In another aspect the invention provides microcapsules prepared by the above-described process, especially microcapsules that incorporate a living cell or a protein or drug, and that have been further treated, if necessary, to reduce immmogenicity.

In yet another aspect the invention extends to a method of treating an animal, particularly a mammal and more particularly a human, by implanting in the animal microcapsules of the invention for the treatment, prevention or alleviation of some medical condition that the animal is, or may be, subject to, or at risk from.

Ionically crosslinkable polymeric materials include polysaccharides, polyanions and polycations. Ionically crosslinkable polysaccharides include, but are not limited to, alginate and natural ionic polysaccharides such as chitosan, gellan gum, xanthan gum, hyaluronic acid, heparin, pectin and carrageenan. Of these alginic acid and alginates are preferred and, although the invention is not restricted to them it will be further described with reference to alginate as the ionically crosslinkable polymeric material.

It is noteworthy that in the process of this invention, the alginate that is used to encapsulate is not first reacted with a reagent to introduce onto the alginate moieties a group containing ethenic unsaturation. The encapsulation can be carried out with commercially available alginate that has not been subjected to any chemical modification. In this respect, the invention differs from the teaching of Soon-shiong et al in U.S. Pat. No. 5,837,747. Thus an extra synthesis step is avoided, as also is the necessity for preparing, say, acrylic anhydride to react with the alginate. Furthermore, the present invention eliminates the risk of contaminating the capsules with small molecules such as acetic acid and acetic anhydride that may be present with acrylic anhydride. Hence, a purification step, such as by dialysis, is not required with the process of the present invention. In addition, encapsulation of the biomedical material within the ionically crosslinkable material prior to the addition of the ethylenically unsaturated monomer reduces the interaction between the ethylenically unsaturated monomer and the encapsulated biomedical material, This limited interaction is beneficial as it limits the exposure of the biomedical material to highly reactive free-radical bearing moieties.

It is also noteworthy that, in the process of the invention, unmodified commercially available alginate can be the sole encapsulating agent or wall-former in the initial capsule formation. This contrasts with the teaching of Desai et al., in U.S. Pat. No. 5,334,640, where alginate is not the sole, nor even the major, encapsulating agent or wall-former in the initial capsule formation.

The process of the invention is simple, low cost, requires no complex steps or chemical syntheses and has the benefit that the biomedical material, e.g, living cells, is incorporated in the initial capsule formation and is therefore somewhat protected from the subsequent photopolymerization conditions.

### DESCRIPTION OF THE FIGURES

Specific embodiments of the present invention are further described with reference to the figures:

FIG. 1 is a photo-micrograph of alginate capsules (dyed to make them visible) prepared in accordance with the conventional procedure (P. Lim et al. (1981) J. Pharm. Sci. 70: 351).

FIG. 2 is a photo-micrograph of alginate capsules (dyed to make them visible) prepared in accordance with the procedure of Soon-shiong (U.S. Pat. No. 5,837,747).

FIG. 3 is an optical microscope picture of a capsule prepared in accordance with the procedure disclosed in U.S. Pat. No. 5,837,747.

FIG. 4 graphs the viability of capsules when subjected to osmotic pressure. Results (A) represents conventional alginate capsules (comparative) (F. Lim et al. (1981) J. Pharm. Sci. 70: 351), while results (B) through (E) are for capsules prepared with varying concentrations of acrylic acid and N-vinylpyrrolidone.

FIG. 5 graphs the viability of capsules when subjected to osmotic pressure, subsequent to storage for a period of 4 months. Results (A) represents conventional alginate capsules (comparative) (F. Lim at al. (1981) J. Pharm. Sci. 70: 351), while results (B), (C) and (E) are for capsules prepared with varying concentrations of acrylic acid and N-vinylpyrrolidone.

FIG. 6 graphs the viability of encapsulated C2C12 cells over time, for capsules of various situations and various process methods described herein.

FIG. 7 graphs the viability of capsules when subjected to osmotic pressure. Results (A) represents conventional alginate capsules (comparative) (F. Lim et al. (1981) J. Pharm. Sci. 70: 351), while results (B) through (E) are for capsules prepared with varying concentrations of sodium acrylate.

FIG. 8 graphs the viability of capsules when subjected to osmotic pressure, subsequent to storage for a period of 4 months. Results (A) represents conventional alginate capsules (comparative) (F. Lim et al. (1981) J. Pharm. Sci. 70-351), while results (B) through (E) are for capsules prepared with varying concentrations of sodium acrylate.

FIG. 9 graphs the viability of capsules when subjected to osmotic pressure, where the capsules have varying concentrations of sodium acrylate and N-vinylpyrrolidone.

FIG. 10 graphs the viability of capsules when subjected to osmotic pressure, subsequent to storage for a period of 4 months, where the capsules have varying concentrations of sodium acrylate and N-vinylpyrrolidone.

FIG. 11 graphs the concentration of calcium in various capsules subsequent to their disintegration. Results (AG) are for conventional alginate capsules (comparative) (F. Lim et al. (1981) J. Pharm. Sci. 70: 351), while the remaining results are for capsules of varying compositions described herein.

FIG. 12 graphs the cell viability in capsules irradiated for various lengths of time. In the cases where there was no irradiation, the capsules were left in contact with the monomers and the photoinitiator for the defined period.

FIG. 13 graphs the viability of cells in capsules subjected to varying osmotic pressures, where the capsules have been irradiated for varying lengths of time.

FIG. 14 graphs the cell viability results for various capsules as determined by an Alamar blue test.

FIG. 15 graphs the capsule viability to osmotic pressure induced by hypotonic solutions of varying concentrations, for capsules with varying compositions and with or without irradiation.

### DESCRIPTION OF PREFERRED EMBODIMENTS

Materials to be encapsulated, for implantation in the body, may be cells, including recombinant cells, such ax myoblasts, fibroblasts, neuronal cells and lymphoblasts. Material to be encapsulated may be proteins, such as enzymes, blood clotting factors, hormones, growth factors, angiogenic factors and anti-tumour growth factors. Materials to be encapsulated may be drugs, such as cisplatin, methotrexate, ganciclovir and anti-tumour chemotoxic drugs in general. The implantatable capsule preferably should be biocompatible and non-cytotoxic, supportive of cell growth, and display controlled permeability. Particularly for implantation of cells, the capsule should be non-biodegradable. For drug delivery, preferably the capsule should degrade over and find period after treatment is finished.

Methods for encapsulating biomedical materials, such as cells, proteins or drugs in particulate form in alginate are known to persons skilled in the art. Any known mechanical method can be Wued, in the prevent invention, to encapsulate biomedical materials. In one technique, an alginate solution in which the particles are suspended is dropped into an aqueous solution containing a salt of a multivalent cation, typically Ca⁺⁺ in a concentration of about 0.5 to 2.0%. As the drops of alginate encounter the multivalent cations, there occurs ionic crosslinking that results in the formation of capsules that fall to the bottom of the vessel containing the multivalent cations.

The alginate solution in which the particles are suspended may be a solution of alginic acid, an alkali metal alginate, an ammonium alginate, or a lower alkyl easter of alginic acid, for example methyl, ethyl or propyl, or a hydroxyalkylester or ether, for example proplene glycol alginate. Alginates are described, for example, in the book by Roy L. Whistler, Industrial Gums, New York, 1973, in the subsection by McNeely and Pettitt on alginates, which is incorporated by reference. It is preferred to use a sodium or potassium alginate. Alginates are composed of units of guluronic acid and units of mannuronic acid. Those alginates having a higher content of guluronic acid are preferred, i.e. those having at least 60% alpha-L-guluronic acid, especially at least 70%.

Particularly suitable alginates are alkali metal and ammonium alginates, in particular sodium and potassium alginates. Propylene glycol alginate is a reaction product of propylene oxide and alginic acid, i.e., the 1,2-propanediol ester of alginic acid.

The solution into which the alginate is dropped is an aqueous solution of a salt of a multivalent cation. Examples of divalent cations are Ca⁺⁺, Mg⁺⁺, Ba⁺⁺ and Sr⁺⁺, while examples of trivalent cations are Al⁺⁺⁺ and Fe⁺⁺⁺. It is preferred to use a halide solution, especially calcium chloride.

The formed alginate microcapsules containing incorporated biomedical material can be subjected to modification with an ethylenically unsaturated, polymerizable monomer. Thus, the microcapsules may be placed in water, together with one or more ethylenically unsaturated polymerizable monomers. If necessary, a salt, for example sodium chloride, may also be present in the water to prevent the rupture of the capsules due to osmotic shock. An initiator is also present to induce polymerization of the ethylenically unsaturated monomers. This results in microcapsules having enhanced strength, as compared with microcapsules not subjected to polymerization of the unsaturated monomers.

As ethylenically unsaturated molecules, i.e., molecules containing carbon-carbon double bonds that are capable of undergoing free radical polymerization, there are mentioned, for example, acrylic acid and alkali metal acrylates, methacrylic acid and alkali metal methacrylates, acrylonitrile, matharlonitrile, allyl alcohol, N-vinylpyrrolidone, and vinyl group terminated poly(alkyleneglycols). As vinyl group terminated poly(alkyleneglycols), there are mentioned esters formed between terminal hydroxy groups of poly(ethyleneglycol) (PEG) and an acid containing carbon-carbon double bonds that is capable of undergoing free radical polymerization, for example acrylic and methacrylic acid. Also mentioned are ethers of PEG, for example vinyl or allyl ethers. Modified PEG's and processes for their preparation are described in U.S. Pat. No. 5,334,640, of Desai et al, the relevant portions of which are incorporated herein by reference. The modified PEG may have a molecular weight up to about 10,000, say in the range 1,000 to 10,000. Of the photopolymerizable molecules, sodium acrylate is preferred. It is possible to use a mixture of polymerizable molecules.

Examples of ethylenically unsaturated polymerizable molecules further include N-vinylpyrrolidone, acrylamide, methacrylamide, acrylic acid, methacrylic acid, sodium and potassium acrylate, sodium and potassium methacrylate, hydroxymethyl acrylate, hydroxyethyl acrylate, ethylene glycol diacrylate, ethylene glycol dimethacrylate, methylene bisacrylamide pentaerythritol triacrylate, pentaerythritol triacrylate, trimethylolpropane triacrylate, tripropylene glycol diaorylate, tripropylene glycol dimethacrylate, glyceryl acrylate, glyceryl mathacrylate and the like.

The ethylenically unsaturated polymerizable molecule is suitably used in an amount from 10 μM to 2M, preferably 0.02 to 0.2M. The molar concentration of polymerizable molecule(s) in the solution is usually not greater than the molar concentration of the alginate solution used in the initial capsule formation. Preferably the molar concentation of the polymerizable molecule(s) is not greater than 50% that of the alginate solution. mixtures of polymerizable molecules can be used. Polymerizable molecules that contain COO⁻ groups are preferred.

In general, polymerization of ethylenically unsaturated molecules is well understood, and a person skilled in the art will have no difficulty in selecting suitable conditions for the polymerization. For example, vinyl polymerization is described generally in T. Tsuruta et al. “Structure and Mechanism in Vinyl Polymerization”, Marcel Dekker, Inc., New York 1969.

A variety of free radical initiators, as can readily be identified by those of skill in the art, can be employed in the practice of the present invention. Thus, photoinitiators, thermal initiators, redox initiators and the like, can be employed.

For example, redox initiators are discussed in greater detail in “Inverse dispersion polymerization of acrylic acid by a water-soluble redox pair” by Liu, Zuifang (Loughborough Univ) Brooks, train W. Polymer, V40, n9 April 1999, P2181-2188. In some instances, redox initiators, in the form of transition metals, can be found in trace amounts in alginate compounds that can be used in the present invention.

Thermal initiation of polymerization is also well understood, such as detailed in “Polymerization of acrylic acids by Chlorocarbon/Metallocene combination Initistor” by Hee-Gweon Wool Bo-Hye Kim; Myoung-shik Cho. In Bull. Korean Chem.; Soc. 2002, V23, N9, P1343.

Suitable UV initiators include 2,2-dimethoxy-2-phenyl acetophenone and its water soluble derivatives, benzophenone and its water soluble derivatives, benzyl and its water soluble derivatives, thioxanthone and its water soluble derivatives, hydroxyl alkyl ketonesi and phenyl trimethyl benzoyl phosphinates and its water soluble derivatives, and the like. Other suitable UV initiators are commercially available as the Irgacure® series, which includes Irgacure® 2959 (2-Hydroxy-1-[4-(2-hydrcxyethoxy) phenyl]-2-methyl-1-propanone), Irgacure® 500. (1-Hydroxy-cyclohexyl-phenyl-ketone 50 wt % Berzophenone 50 wt %), Irgacure® 819 (Phosphine oxide, phenyl bis (2,4,6-trimethyl benzoyl), and its water soluble derivatives

There are many other photoinitiators, however, and a person skilled in the art will have no difficulty in determining suitable polymerization conditions, possibly with the aid of routine testing that does not require the exercise of any inventive faculty.

The photoinitiator can also be used with a co-catalyst, such as a trialkylamine, for example triethanolamine. Triethanolamine is suitably used in an amount of about 0.1 μM to 0.3M, preferably in an amount of 3 mM to 0.2M.

The nature of the biomedical material that in encapsulated must be borne in mind when selecting conditions, however. If living cells, or proteins or drugs that are YV sensitive, are encapsulated, then the light used for polymerization should ideally be in the visible rane, and the time, temperature and the photoinitiator should be selected accordingly. For example, some dyes of the eosin family are approved for human consumption and will serve as a photoinitiator in the visible light range. The photoinitiator may be used in an amount of about 0.1 μM to 0.15 mM, preferably 0.01 mM to 0.015 mM.

After polymerization, the capsule are collected and, if necessary, are treated to reduce their tendency to elicit an immune response when administered to an animal. As is known, this can be done by coating with, for example, poly-L-lysine or poly-L-argininze, followed by a further coating with, for example an alginate. It is preferred that this further alginate coating shall be applied using the same chemistry as used to apply the first, inner alginate coating, ire., if sodium alginate and calcium chloride solution were used to form the inner alginate coating than it is preferred to use sodium alginate and calcium chloride to form the outer alginate coating

Capsules prepared in accordance with the prior art, i.e., capsules prepared using the encapsulation reaction between sodium alginate and calcium chloride, without subsequent addition of a photopolymerizable monomer and irradiation, are prone to lose calcium ions and consequently lose their integrity. As demonstrated in an example set forth below, when such capsules were placed in an aqueous solution of sodium EDTA, the capsules rapidly disintegrate. In contrast, capsules prepared in accordance with the present invention have a much greater stability in the sodium EDTA solution. The inventors have also found that if they take a solution of sodium alginate together with a mixture of vinyl monomers such as N-vinylpyrrolidone and acrylic, add a photoinitiator such as Irgacure 2959 (0.2%) and then irradiate at 350 nm, a gel is formed, indicating that crosslinking has occurred this may be because hydrogen abstraction from alginate has occurred, to produce moieties that can undergo free radical polymerization. Clearly it cannot be Ca⁺⁺ ion crosslinking as no Ca⁺⁺ ions are present.

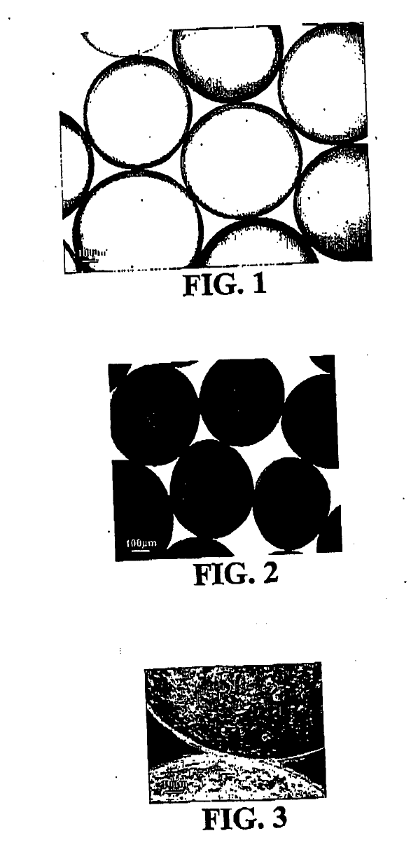

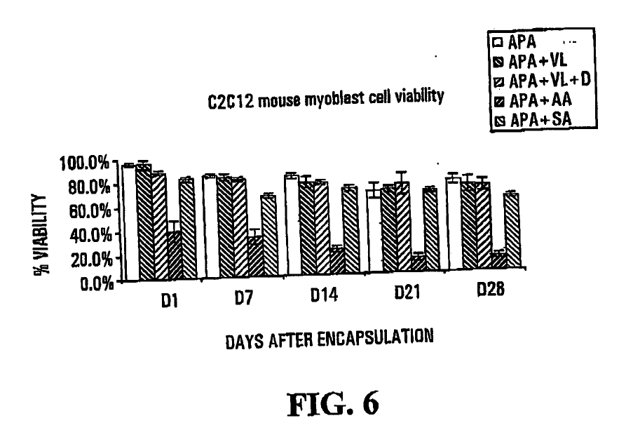

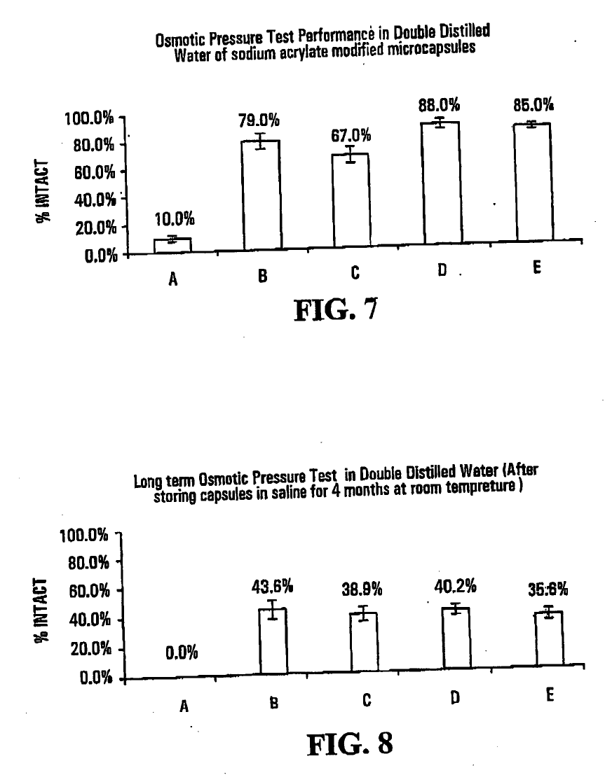

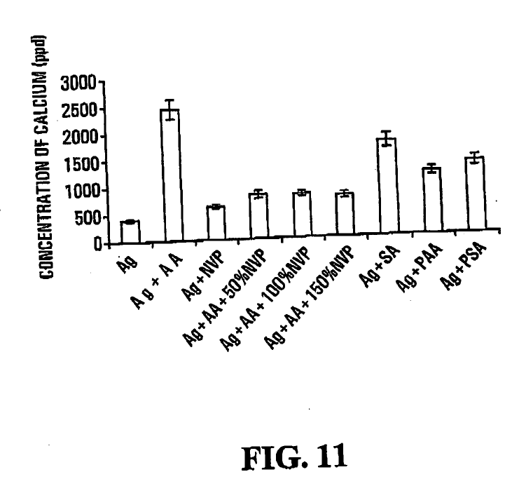

The invention is further illustrated in the following examples and in the accompanying figures, FIGS. 1 and 2 are photo-micrographs of alginate capsules (dyed to make them visible) prepared in accordance with the conventional procedure and with the procedure of Soon-Shiong (U.S. Pat. No. 5,837,747) respectively. Since both figures are to the same scale, it can be seen that the capsules of Soon-Shiong are smaller than those of the conventional procedure, FIG. 3 is an optical microscope picture of a capsule prepared according to U.S. Pat. No 5,837,747, showing surface roughness that is undesirable for capsules to be implanted. FIGS. 4 and 5, 7 to 10 and 15 illustrate data acquired from testing microcapsules made in accordance with the invention, and also data from testing microcapsules made in accordance with prior art. FIGS. 6 and 12 to 14 show data of cell viability for encapsulated cells. FIGS. 7 to 10 show results obtained when subjecting various capsules to osmotic pressure tests. FIG. 11 shows results of tests to determine calcium content of various capsules.

From the results obtained in the following examples and from the accompanying Figures, it can be seen that increases in the concentration of monomer and increases in polymerization period both increase the mechanical strength of final microcapsules.

The following examples are offered by way of illustration and not by way of limitation.

### EXAMPLES

In the following examples there are references to ethylenically unsaturated monomer (i.e. acrylate), expressed as a percentage. The base of the percentage is the concentration of ionically crosslinkable material (i.e. alginates) in the solution used in the initial encapsulation step. To illustrate, if the weight of sodium alginate in the solution used to form the initial alginate capsule is 0.03 gms, and the weight of acrylic acid in the solution in which photopolymerization occurs is 0.003 gms, then thin is referred to as “10% acrylic acid”. A concentration of 100% indicates that the ethylenically unsaturated monomer and the ionically crosslinkable material are in a 1:1 ratio. Where other ethylenically unsaturated monomers are used, e.g. sodium acrylate or N-vinylpyrrolidone then the amount used war the molar amount corresponding to the molar amount of acrylic acid present in a mixture defined as a weight percent. Thus a “10% sodium acrylate” modification would use a molar amount of sodium acrylate that corresponds to the molar amount of acrylic acid in a “10% acrylic acid” modification.

All solutions were sterilized by either autoclave or filtration through 0.2 μm filter. A solution of ethyl eosin (0.04% w/v) was prepared in 0.5 to 2.0%, preferably 1.1% CaCl₂ and NaCl in amount to maintain an osmotic pressure balance solution. Ethyl eosin (yellowish) was used as the photoinitiator in the subsequent modifications using visible wavelength light. Irgacure 2959 (Ciba Company) was used with long wavelength UV light irradiation. Saline refers to physiological saline (NaCl 0.9%).

The light source used for photoinitiation consisted of four a watt tubes obtained from Microlite Scientific, For the UV irradiations, F8T5/BLB SW T15*300 tubes were used, providing irradiation at wavelengths of about 350 nm or greater. For visible wavelength irradiations, F8T5/CW Fluor.T15*300 with EG408 TS UV tubeguard filters were used. The four lamps were housed in reflector assembly with the lamps being 4 cm from the capsules being irradiated.

In the examples, alginates commercially available under two trademarks were used. Kelton LV is an alginate that has a fine mesh size (˜150 microns), low viscosity (10˜60 mPa.S) and molecular weight MN of 428,000 when measured by gel phase chromatography (GPC). Improved Kelmar has a medium mesh size (˜165 microns), high viscosity (250˜500 mPa.S) and MW of 611,000 measured by GPC.

For some of the following examples, C2C12 cells were immobilized in alginate microcapsules using standard methodologies, i.e. using sodium alginate and calcium chloride as the salt of the multivalent cation. C2C12 cells are cells of a myoblast cell line and are available to the public from the American Tissue Culture Collection (ATCC). Details are available at

“http;//www.biotech.ist.unige.it/cldb/cl563.html” and in D. Yaffeand O. Saxel “Serial passaging and differentiation of myogenic cells isolated from dystrophic mouse muscle” Nature (1977) Dec. 22-29; 270(5639):725-7. The encapsulation of the C2C12 cell line is discussed in P. L. Chang, “Calcium phosplate-mediated DNA transfection”, in J. A. Wolff J A: Gene Therapeutics. Boston, Mass., Birkhauser Boston, 1994, p157 and in Gonzalo Horelano at al. “Delivery of Human Factor IX in Mice by Encapsulated Recombinant Myoblasts: A Novel Approach Towns Allogeneic Gene Therapy of Hemophilia B” Blood; 1996 Jun. 15 87(12), 5095-103.

### Example 1

Detailed Procedure with Acrylic Acid using Irgacure as the Photoinitiator with Long Wavelength UV Light

A solution containing 100 μl of 0.2% Irgacure 2959 in saline, 30 μl of 1.39 M Acrylic Acid in saline and 50 μl of 0.834M N-vinylpyrrolidone in saline were added to 2 ml of calcium microcapsule in a 60 mm cell culture dish. After a gentle shaking, the microcapsules were immediately enclosed to UV light (wavelength of approximately 350 nm) for varying periods at 4° C. Afterwards, the capsules were washed with fresh 1.1% CaCl2 to remove unreacted reagents. The capsules were then treated with poly-L-lysine and alginate in the standard manner. Sterile techniques were used throughout the whole procedure.

FIG. 4 shows results of osmotic pressure tests in double distilled water on capsules of the invention and “standard” capsules, i.e., capsules that had not been subjected to photopolymerization with an ethylenically unsaturated monomer. The osmotic pressure test measures the strength of microcapsules, by calculating the percentage of intact capsules after exposure to doubly distilled water. The test involved shaking the capsules in the water for three hours, after which the numbers of broken and intact capsules were counted. Most tests were conducted in doubly distilled water.

The microcapsules in accordance with the invention were subjected to photopolymerization using the ethylenically unsaturated monomers specified below wherein AA is acrylic acid and NVP is N-vinylpyrrolidone, and subsequently were subjected to light irradiation for the period specified. Details are given below and in FIG. 4:
A—Standard alginate-poly-L-Lysine-alginate microcapsules.
B—Modified with acrylic acid (AA) and N-vinylpyrrolidone (CVP). (AA was 15 μl of 1.39M solution and NWP 12.5 μL of a 0.834M solution.) Irradiation time lh using UV light.
C—Modified with acrylic acid (AA) and N-vinylpyrrolidone (NVP). (AA was 30 μL of 1.39M solution and NVP 25 μL of a 0.834M solution.) Irradiation time 1 h using UV light.
D—Modified with acrylic acid (AA) and N-vinylpyrrolidone (NVP). (AA was 30 μL of 1.39M solution and TVP 25 μL of a 0.834M solution.) Irradiation time 1.5 h using UV light.
B—Modified with acrylic acid (AA) and N-vinylpyrrolidone (NVP) (AA was 60 μL of 1.39M solution and NVP 50 μL of a 0.834M solution.) Irradiation time 1 h using UV light.

It can be seen that none of the “standard” capsules (A) survived the osmotic chock. Of those in accordance with the invention, namely (B), (C), (D) and (E), the percentages intact after the test ranged from 77.6% to 98.0%.

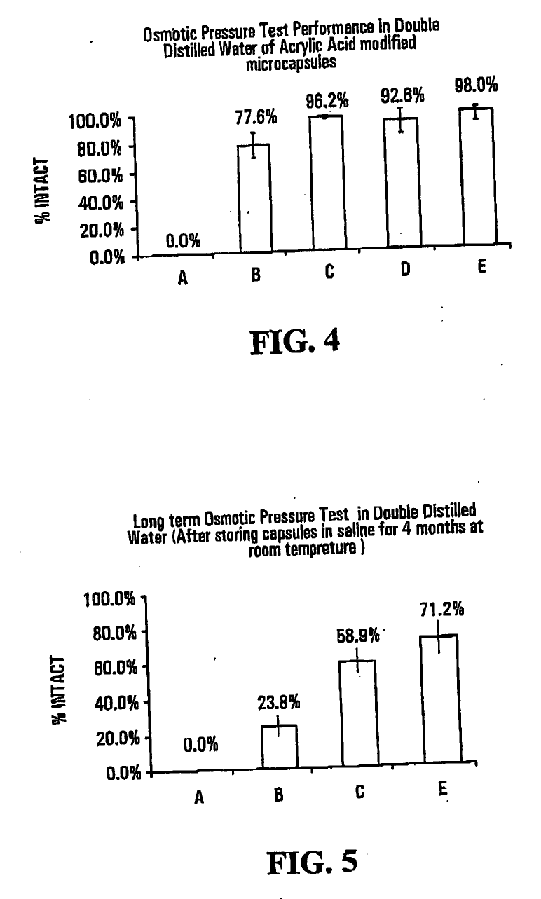

FIG. 5 shows the result of an osmotic pressure teat similar to the one illustrated in FIG. 4, except that the microcapsules were first stored at room temperature for four months in saline solution. Again, none of the “standard” cells survived the test, whereas those in accordance with the invention survived in percentages ranging from 23.8% to 71.2%, indicating good long-term stability.

### Example 2

Detailed Procedure with Acrylic Acid using Ethyl Eosin as the Photoinitiator

The capsules as obtained in Example 1 were suspended in 10 ml of an ethyl eosin solution (see above for formulation) for 2 min to allow uptake of the dye, then washed three times with fresh 1.1% CaCl₂ to remove non-absorbed dye. The microcapsules were transferred from the CaCl₃ solution to a 0.9% NaCl solution for photomoaification.

A solution was prepared by admixing 100 μl of 4% w/v of triethanolamine in physiological saline, 30 μL of 1.39M acrylic acid in physiological saline and 25 μl of 0.832M N-vinylpyrrolidone in physiological saline. The solution was added to 2 ml of these microcapsules contained in a 60 mm cell culture dish. After a gentle shaking, the microcapsules were immediately exposed to visible light (wavelength greater than 400 nm) for a defined period at 4° C. After the irradiation, the capsules were washed with fresh 1.1% CaCl₂ solution to remove unreacted reagents. The capsules were then treated with poly-L-lysine and alginate in the normal manner. Sterile techniques were used throughout the while procedure. The concentration of initiator and the period of irradiation were optimized to achieve similar osmotic pressure test results. It was found that the concentration of monomer, co-catalyst and polymerization period affected the mechanical strength of final microcapsules.

FIG. 6 shows cell survival tests wherein the cells have been encapsulated as set forth below:
APA Alginate-poly-L-lysine-Alginate microcapsules
APA+VL calcium alginate capsules that had been exposed to visible light for 30 minutes
APA+VL+D Calcium alginate capsules that had been immersed into ethyl eosin dye solution, then exposed to visible light for 30 minutes
APA+AA Calcium alginate capsules that had been modified with acrylic acid (A) and N-vinylpyrrolidone (NYP). (A was 30 μL of 1.39M solution and NIM 24 μL of a 0.834M solution.) Irradiation time 30 min.Modified with sodium acrylate (WA) and N-vinylpyrrolidone
APA+SA (NVP). (NaAA was 30 μL of 1.39M solution and NVP was 24 μL of a 0.83M solution.) Irradiation time 30 min.

The cell survival was determined using the trypan blue test as described in H. J. Phillips, 1973, “Dye exclusion teats for cell viability”, pp. 406-408. In: P. F. Kruee and M. K. Patterson (eds.), Tissue culture methods and applications. Academic Press, New York.

It can be seen there is little change in cell survival, as measured by the trypan blue test, of capsules that were simply irradiated or irradiated with absorbed dye as compared to standard capsules. Note these are comparative experiments to show that light and light/dye does not affect perforce to a significant degree. The capsules modified with acrylic acid, as described in this invention, exhibited poorer cell survival than those modified with sodium acrylate, which had much the same cell survival as the initial control experiment.

### Example 3

Detailed Procedure with Sodium Acrylate using Ethyl Eosin as the Photoinitiator with Visible Wavelength Light

A procedure similar to Example 2 was used, with acrylic acid are the ethylenically unsaturated monomer and with ethyl eosin as an initiator. The same molar amount of sodium acrylate (30 μl of a 1.39M solution) and varying concentrations of N-vinylpyrrolidone were added to 2 ml of the suspended capsules. (The amount of sodium acrylate used corresponds to a 10% modification.)

FIGS. 7 and 8 show results of osmotic pressure tests conducted on capsules formed with varying amounts of sodium acrylate. The tests were carried out upon formation of the capsules, and after storage in saline for Tofthu at room temperature, respectively. Details are as follows:
A—Standard alginate-poly-L-Lysine-alginate microcapsules
B—10% w/w sodium acrylate (SA) (30 μl 1.35M) to Alginate
C—20% w/w sodium acrylate (SA) 60 μl 1.39M to Alginate
D—50% w/w sodium acrylate (SA) 150 μl 1.39M to Alginate
E—100% w/w sodium acrylate (SA) 300 μl 1.39M to Alginate

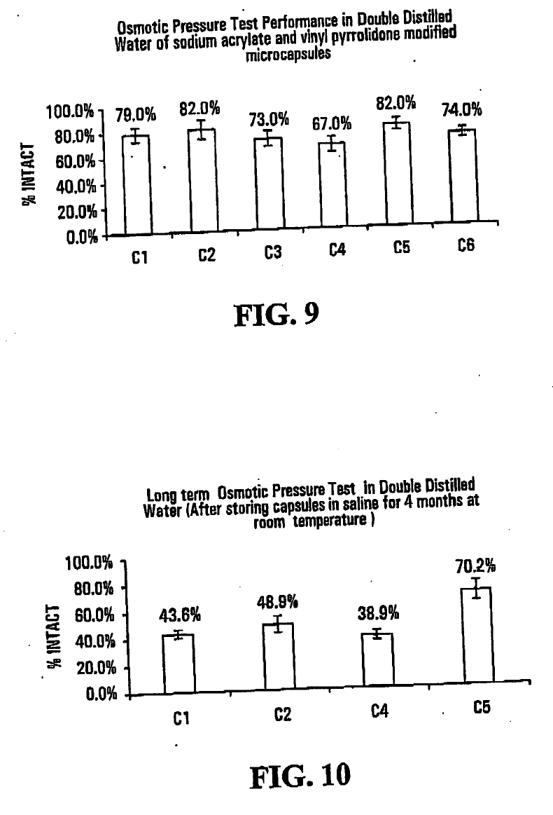

FIGS. 9 and 10 show results of similar tests with capsules formed with varying amounts of both sodium acrylate and MVP. Details are as follows:
C1—10% w/w sodium acrylate (SA) (30 μl of 1.39M solution) to Alginate.
C2—10% w/w sodium acylate(SA) (30 μl of 1.39M) and 25 μl 0.834M N-vinylpyrrolidone (NVP) to Alginate.
C3—10% w/w sodium acrylate (SA) (30 μL of 1,39M) and 50 μl 0.834M N-vinylpyrrolidone (NVP) to Alginate.
C4—20% w/w sodium arylate(SA) (60 μl of 1.39M) to Alginate.
C5—20% w/w sodium acrylate (SA) (60 μl of 1.39M) and 50 μl 0.834M N-vinylpyrrolidone (NVP) to Alginate.
C6—20% w/w sodium acrylate (SA) (60 μl of 1.39M) and 100 μl 0.834M N-vinylpyrrolidone (NVP) to Alginate.

The osmotic pressure testBs aow that the presence of a co-monomer (NVP) does not play an important a role in the long term storage test as it does in the acrylic and system in the short term tests. Its effect over the long term is comparable to that found with the acrylic acid modified capsules.

### Example 4

EDTA Experiments

Standard capsules (F. Lim et al. (1981) J. Pharm. Sci. 70: 351) were prepared and placed in a 0.17M EDTA solution. The time until the capsules collapsed was observed and was found to be less than one minute. Capsules prepared in accordance with the invention, with UV light initiation, using 10% sodium acrylate (0.003 gm of sodium acrylate to 0.03 gm of alginate) were also prepared and placed in an EDTA solution of the same strength, and time until collapse increased to 5 minutes. Better MDTA stability was achieved, in accordance with the invention, using 100% sodium acrylate (0.03 gm of sodium acrylate to 0.03 gm of alginate) and 0.044 gm of NVP.

### Example 5

Detailed procedure for UV-initiated Sodium Acrylate and N-vinylpyrrolidone Modification to the Alginate Capsules using Long-wavelength Ultraviolet Light

Capsules containing C2C12 cells immobilized in alginate were prepared using the standard methodologies described earlier.

A solution was prepared by mixing 100 μl of Irsacure 2959, 60 μl of 1.39 M sodium acrylate in physiological saline and 100 μl of 0.832 M N-vinylpyrolidone in physiological saline. The solution was added to 2 ml of the capsules contained in a 60 mm cell culture dish. After a gentle shaking, the capsules were immediately exposed to UV light (wavelength around 350 nm) for a defined period of time at 0° C. Afterwards, the capsules were washed with fresh 1.1% CaCl₂ solution to remove unreacted reagents. The capsules were then treated with poly-L-lysine and alginate in the standard manner. Sterile techniques were used throughout the entire procedure. The concentration of monomer and polymerization period affected the mechanical strength of the final microcapsules

The Alamar blue test was selected to detect the viability of the encapsulated C2C12 cells 100 μl of the capsules to be tested for cell viability were placed in a well of a 24-well plate with media [DMEM (Dulbecco's Modified Eagle Medium) with 10% fetal bovine serum, penicillin (100 U/ml )-streptomycin (100 μg/ml) and 2 mM of L-glutamine (Gibco, BRL)] to a total volume of 500 μl, and 50 μl of Alamar Blue was added to each sample. The plate was incubated at 37 degrees Celsius for four hours. After inubltion, 100 μl of solution was taken from each sample and put on a microtiter plate. The fluorescence of each sample was read using a fluorometer (Cytofluor II) with an excitation wavelength of 590 nm and an emission wavelength of 530 nm. The number of viable cells was determined by comparing fluorescence values with a standard curbe generated from non-encapsulated cells.

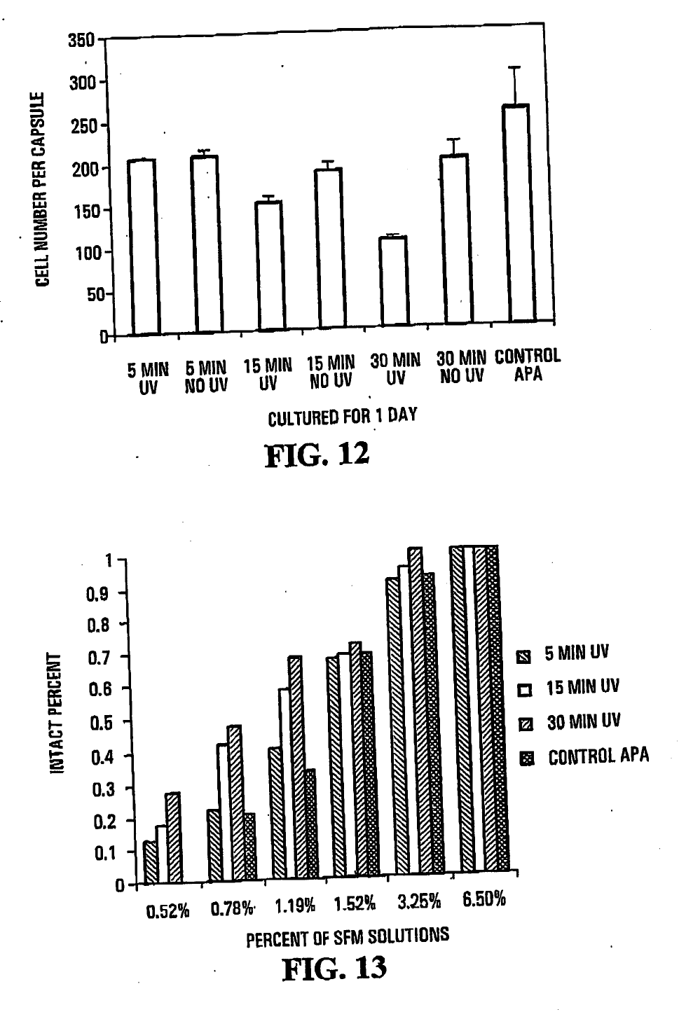

FIG. 12 shows the result of the Alamar blue test for cell viability of the capsules modified with different irradiation times with UV-light, The Alamar blue test was used in this example an it is a more sensitive test than the Trypan blue test used earlier. It can be seen that although the UV irradiation brings damage to the encapsulated cells, over 60% of living cells remain after the full process of modification.

Capsules modified with 20% sodium acrylate, similar to those shown in FIG. 12 were tested using an osmotic pressure test. The percentage of intact capsules after exposure to a series of hypotonic solutions was determined. Hypotonic solutions were made by diluting serum free media (SFM) with water. Solutions of 0%, 0.39%, 0.78%, 1.56%, 3.25%, 6.25% and 12.5% SFM, having respective oemolarities of 0, 1.4, 2.8, 5.5, 11.1, 21.3 and 42.5 mOsm, were used. The test involves shaking the capsules in one of the solutions for three hours, after which the numbers of broken and intact capsules are counted. The results are shown in FIG. 13.

It can be seen from FIG. 13 that the strength of the capsules in the osmotic pressure test increased with irradiation time. The capsules were substantially stronger than the control alginate capsules to which no modification had been applied. This is particularly evident at the lowest SFM concentrations where the osmotic pressure difference is the greatest.

### Example 6

The Effect of Irradiation on Capsules Produced using Irgacure 2959 with Sodium Acrylate and N-vinylpyrrolidone

A solution was prepared by admixing 100 μl of Irgacure 2959, 100 μl of 0.832 M N-vinylpyrrolidone in physiological saline. The solution was added to 2 ml of the microcapsules contained in a 60 mm cell culture dish. After a gentle shaking, the microcapsules were kept in the cell culture dish for a defined period at 0° C. Some of the capsule samples were irradiated using long-wavelength UV light as described earlier. Afterwards, the capsules were washed with fresh 1.1% CaCl₂ solution to remove unreacted reagents. The capsules were then treated with poly-L-lysine and alginate in the standard manner. Sterile techniques were used throughout the whole procedure.

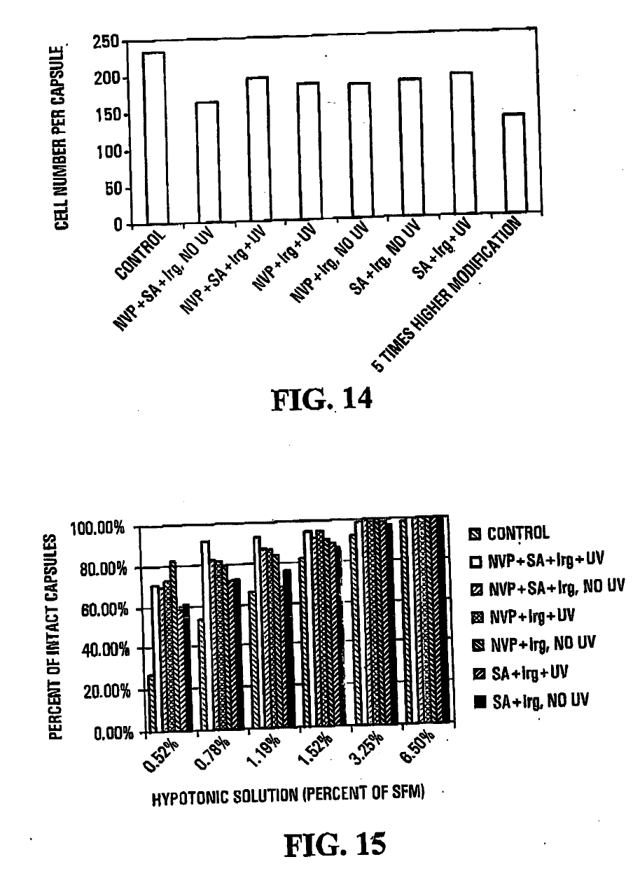

FIG. 14 shows the results of cell viability tests, using Alamar blue, for cells produced under various modification conditions. It is evident that the cells had a good survival rate of over 70% of the control value, regardless of the type or length of the modification process or whether light was used or not. At much higher concentrations of the modifying reagents some further loss of cell viability was observed (last entry in FIG. 14). In FIG. 14, NVP represents N-vinylpyrolidone, SA represents sodium arylate and Irg represents Irgacure 2959.

FIG. 15 shows the results of osmotic pressure tests with various modified capsules. The results obtained with the irradiated capsules are consistent with the results presented in previous examples. It should also be noted that even in the absence of light but in presence of the vinyl monomers (sodium acrylate and/or N-vinylpyrrolidone) and initiator, there was a considerable increase in capsule strength.

TABLE 1
below summarizes results obtained with various monomers and
monomer mixtures using eosin as the photoinitiator:

| | | | OPT in DD- | | Cell | |
|---|---|---|---|---|---|---|
| Monomers | | | H₂O | | Survival | |
| A | B | Concentration | ST | LT | VL | UV |
| Acrylic | None | 10% | − | −− | ND | − |
| acid | | 20% | + | −− | | |
| | | 50% | + | −− | | |
| | | 100% | − | −− | | |
| Acrylic | N-Vinyl | 10% | +++ | + | − | − |
| acid | pyrrolidone | 20% | +++ | + | | |
| | | 50% | − | −− | | |
| | | 100% | − | −− | | |
| Sodium | None | 10% | + | − | ND | ++ |
| acrylate | | 20% | + | − | | |
| | | 50% | +++ | + | | |
| | | 100% | +++ | + | | |
| Sodium | N-Vinyl | 10% | + | − | +++ | ++ |
| acrylate | pyrrolidone | 20% | + | − | | |
| | | 50% | +++ | + | | |
| | | 100% | +++ | + | | |
| N-Vinyl | None | 10% | + | − | ND | ++ |
| pyrrolidone | | 20% | + | − | | |
| | | 50% | +++ | + | | |
| | | 100% | +++ | + | | |

Where
“OPT” osmotic pressure test in double-distilled water
“ST” short term stability
“LT” long term stability (after 4 months in saline at room temp.)
“+++” OPT > 80% of capsules remain intact
“++” OPT > 70%
“+” OPT > 50%
“−” OPT > 20%
“−−” OPT = 0

Concentration “%” is defined as the weight percent of monomer A to sodium alginate. Monomer B concentration matches that of A on a molar basis. ND indicates experiments not done. Cell survival in visible light process determined using trypan blue; in UV light process using alamar blue

### Example 7

Microcapsules which were prepared using a variety of conditions were caused to disintegrate using sodium-EDTA, and then analysed for their calcium content using an ICP (inductively coupled plasma) analytical technique. The results are shown in the accompanying FIG. 11. It can be seen that by carrying out the method of the invention using either acrylic acid or sodium acrylate as sole polymerizable molecules, there is a very significant increase in the amount of calcium present in the capsules. The calcium content experiment described above shows that the presence of acrylic moieties augments the ionic cross-linking component. Presumably, the origin of this effect is that in as applicant's process using acrylic acid or sodium acrylate, the carbqcylic acid content of the capsules was effectively increased, thereby enhancing ionic cross-linking. This is partially evidenced by the heightened calcium contents of capsules made by mixir poly(modium alrylate) or poly(acrylic acid) with the alginate (FIG. 11).

FIG. 11 shows concentration of calcium in a solution obtained by dissolution of 10 μL of microcapsules in 10 mL of 2% hydrogen peroxide.

Details are as follows:
AA standard alginate capsules;
Ag+AA alginate capsules modified with 20% acrylic acid (wt % as compared to alginate);
Ag+NVP alginate modified with NVP (molar amount of NVP corresponds to the molar amount of acrylic acid in a 20% acrylic acid modification);
Ag+AA+NVP alginate capsules modified with 20% acrylic acid and NVP, the amount of NVP is expressed as a molar % of the acrylic acid;
Ag+SA alginate capsules modified with 20% sodium alginate (molar amount of SA corresponds to the molar amount of acrylic acid in a 20% acrylic acid modification);
Ag+PAA alginate capsules made with incorporation of 20% poly(acrylic acid) (dressed as a weight % comwpared to alginate);
Ag+PSA alginate capsules foxmed with incorporation of 20% sodium poly(acrylate) (dressed as a weight % compared to alginate).

All publications, patents and patent applications cited in this specification are herein incorporated by reference as if each individual publication, patent or patent application were specifically and individually indicated to be incorporated by reference. The citation of any publication is for its disclosure prior to the filing date and should not be construed as an admission that the present invention is not entitled to antedate such publication by virtue of prior invention.

Although the foregoing inventions been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

It must be noted that as used in this specification and the appended claims, the singular forms “a,” “an,” and “the” include plural reference unless the context clearly dictates otherwise. Unless defined otherwise all technical and scientific termus used herein have the same meaning as commonly understood to one of ordinary skill in the art to which this invention belongs.

1: A process for encapsulating a biomedical material, which comprises incorporating the biomedical material in capsules of an ionically crosslinkable polymeric material, and contacting the capsules with a liquid vehicle comprising an ethylenically unsaturated molecule and an initiator.

2: A process according to claim 1, wherein the capsules and the liquid vehicle comprising an ethylenically unsaturated molecule and an initiator are irradiated to induce polymerization of the ethylenically unsaturated molecule.

3: A process according to claim 1, wherein the ionically crosslinkable polymeric material is an alginate.

4: A process according to claim 1, wherein the ethylenically unsaturated molecule is selected from the group comprising acrylic acid, sodium acrylate and N-vinylpyrrolidone.

5: A process according to claim 1, wherein the initiator is selected from ethyl eosin and 2-hydroxy-1-[4-(hydroxyethoxy)phenyl]-2-methyl-1-propanone.

6: A process according to claim 2, wherein the capsules and the liquid vehicle comprising an ethylenically unsaturated molecule and an initiator are irradiated at a wavelength of about 300 nm or greater.

7: A process according to claim 1, wherein the molar ratio of ionically crosslinkable polymeric material to ethylenically unsaturated molecule is from about 1:1 to about 20:1.

8: A process according to claim 1, wherein the molar ratio of ionically crosslinkable polymeric material to ethylenically unsaturated molecule is from about 1:1 to about 10:1.

9: A process according to claim 1 which comprises the further steps of coating the encapsulated biomedical material with a poly-amino acid, and subsequently coating with an ionically crosslinkable polymeric material.

10: A microcapsule comprising a biomedical material which is encapsulated in a coating, wherein the coating comprises a substantially inner layer of an ionically crosslinked polymeric material which is reinforced by a substantially outer layer of a crosslinked ethylenically unsaturated molecule, wherein the molar ratio of ionically crosslinked polymeric material to polymerised ethylenically unsaturated molecule is from about 1:1 to about 20:1.

11: A microcapsule according to claim 10, wherein the ionically crosslinked polymeric material is an alginate.

12: A microcapsule according to claim 10, wherein the ethylenically unsaturated molecule is selected from the group comprising acrylic acid, sodium acrylate and N-vinylpyrrolidone.

13: A microcapsule according to claim 10, which has an additional coating comprising a poly-amino acid and a further coating comprising a second ionically crosslinked polymeric material.

14: A method for introducing a biomedical material into an animal, which comprises implanting in the animal a microcapsule as claimed in claim 10.

15: A process according to claim 1, wherein:
(a) the ionically crosslinkable polymeric material is an alginate;
(b) the ethylenically unsaturated molecule is selected from the group comprising acrylic acid, sodium acrylate and N-vinylpyrrolidone;
(c) the initiator is selected from ethyl eosin and 2-hydroxy-1-[4-(hydroxyethoxy)phenyl]-2-methyl-1-propanone; and
(d) the molar ratio of ionically crosslinkable polymeric material to ethylenically unsaturated molecule is from about 1:1 to about 20:1.

16: A process according to claim 15, wherein the capsules and the liquid vehicle comprising an ethylenically unsaturated molecule and an initiator are irradiated at a wavelength of about 300 nm or greater to induce polymerization of the ethylenically unsaturated molecule.

17: A process according to claim 16 which comprises the further steps of coating the encapsulated biomedical material with a poly-amino acid, and subsequently coating with an ionically crosslinkable polymeric material.

18: A microcapsule according to claim 10, wherein:
(a) the ionically crosslinked polymeric material is an alginate; and
(b) the ethylenically unsaturated molecule is selected from the group comprising acrylic acid, sodium acrylate and N-vinylpyrrolidone.

19: A microcapsule according to claims 18, which has an additional coating comprising a poly-amino acid and a further coating comprising a second ionically crosslinked polymeric material.
